(19) United States
(12) Patent Application Publication
(10) Pub. No.: US 2005/0100000 A1
(43) Pub. Date: May 12, 2005

(54) Method and system for windows based traffic management

(75) Inventors: Alisdair Faulkner, Hawthorndene (AU); Steve Woodberry, Woodcroft (AU); Alan Noble, Marino (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Foursticks Pty Ltd, Adelaide (AU)

(21) Appl. No.: 10/777,788

(22) Filed: Feb. 11, 2004

(30) Foreign Application Priority Data
Nov. 7, 2003 (AU) 2003906165

(51) Int. Cl. H04L 12/66

(52) U.S. Cl. 370/352

(57) ABSTRACT

A method for shaping packet switched data traffic between a terminal device of a type including an operating system adapted to execute a plurality of applications and a network resource. The method includes selecting of an allocation policy to allocate access to the network resource between one or more primary applications and other applications and selecting characteristics associated with a primary application. The method examines interactions between one or more applications and the operating system to identify which of a plurality of applications is the primary application and classifies data packets according to their association with the primary application. A step of allocating access to the network resource in accordance with the policy is included.

### BACKGROUND OF THE INVENTION

The present invention relates generally to computer networking techniques. More particularly, the present invention provides a method and system for shaping packet switched data traffic between a terminal device of a type including an operating system adapted to execute a plurality of applications and a network resource. Merely by way of example, the present invention can be applied to network multitasking operations, but it would be recognized that it has a much broader range of applicability.

A computer network typically comprises a plurality of interconnected devices that transmit and receive packet switched data. Each network device preferably includes network communication software, which may operate in accordance with Transport Control Protocol/Internet Protocol (TCP/IP). TCP/IP consists of a set of rules defining how devices interact with each other. In particular, TCP/IP defines a series of communication layers, including a transport layer and a network layer. At the transport layer, TCP/IP includes both the User Data Protocol (UDP), which is a connectionless transport protocol, and TCP which is a reliable, connection-oriented transport protocol. When a process at one network device wishes to communicate with another device, it formulates one or more messages and passes them to the upper layer of the TCP/IP communication stack. These messages are passed down through each layer of the stack where they are encapsulated into packets and frames. Each layer also adds information in the form of a header to the messages. The frames are then transmitted over the network links as bits. At the destination device, the bits are re-assembled and passed up the layers of the destination device's communication stack. At each layer, the corresponding message headers are also stripped off, thereby recovering the original message which is handed to the receiving process.

Traffic between particular devices is a traffic flow. A traffic flow is a set of data packets that typically correspond to a particular task, transaction or operation and may be identified by various network and transport parameters, such as source and destination IP addresses, source and destination TCP/UDP port numbers, and transport protocol.

The treatment that is applied to different traffic flows may vary depending on the particular traffic flow at issue. For example, an online trading application may generate stock quote messages, stock transaction messages, transaction status messages, corporate financial information messages, print messages, data backup messages, etc. A network administrator may wish to apply a different policy or service treatment (“quality of service” or “QoS”) to each traffic flow. For example, a network administrator may want a stock quote message to be given higher priority than a print transaction. Similarly, a $1 million stock transaction message for a premium client should be assigned higher priority than a $100 stock transaction message for a standard customer.

Within an enterprise or internet service provider (ISP), the network administrator is able to allocate network resources, such as bandwidth (transmission speed), using a concept called policy-based networking (PBN) which attempts to map a traffic flow to a policy which determines the amount of bandwidth, normally defined in terms of a percentage, transmission speed, priority number or proportional weighting, that a particular flow is able to access. Where the allocation of network resources is done with the intent of improving or modifying the performance of a traffic flow, this is often referred to by those skilled in the art as a Quality of Service (QoS) policy.

Currently QoS policies, need to be mapped to network flows using information that is available in the network packet. These network flows are often identified by network elements or policy decision points by network primitives available within the Internet Protocol fields such as destination or sources address, port number, or differentiated service field.

Once the QoS policy has been defined and propagated to a network device, such as a router, the QoS policy is put into effect by inspecting network packets as they are intercepted by the network device and then performing an action on the packet based upon the matching policy. Such an action might be to drop the packet, or queue (delay the transmission of) the packet if the flow has exceeded its allocated quota of access to the transmission bandwidth. Alternatively, the action might be to expedite a particular packet in front of packets belonging to other flows that may have previously been queued for transmission.

A deficiency of current policy-based QoS approaches is that they require an understanding of a traffic flow's purpose, usage and requirements, and the means of translating that into the know-how necessary to allocate network resources. In a large corporate or ISP environment, this knowledge may not reside in the same person or department. Conventional Application Managers may have the detailed knowledge of the resource requirements of applications, transactions or databases, but not the expert knowledge in applying the necessary router configurations to achieve the required access to network resources.

This required knowledge is even larger obstacle to applying QoS to traffic flows in consumer or SME environments where such technical knowledge is too expensive to procure.

Yet another deficiency of present methods to the application of QoS to a traffic flow is that they relate to network elements and not to end-points themselves. This may be an acceptable handicap in a corporate environment where these client devices are connected to a LAN where the “last mile” bandwidth is much higher than the transmission speed on the Wide Area Network (WAN) interconnecting these LANs. However in corporate wireless environments, where bandwidth is much more restricted in comparison to fixed-line Ethernet devices, and in legacy networks such as dial-up networks used by consumers and SOHO's, the last mile presents an issue that cannot be resolved without some intelligent co-operation of the end-device itself.

The existing deficiencies can be understood when it is considered in terms of the OSI (Open System Interconnect) layered model. The OSI Layers are decoupled, meaning that information about upper layers is abstracted away from the operation of the lower layers. From the Network Layer's perspective, connections are open and closed by anonymous processes on an operating system. Therefore, at the Network Layer and below, information such as the Application Window, sub-application or task which generated the traffic is not natively available. To work around this, prior art methods use information contained in the data packet itself in order to classify and manage traffic at the Network and Datalink layer. Such well known methods use information contained in the packet headers, such as Port Number in the Layer 4 header, or information contained in the data payload, such as a string referring to a web address, in order to classify data traffic according to upper layer concepts. However, no such methods exist which enable data packets at the Networking and Datalink level to be classified and managed according to Operating System primitives such as Window, Process or Thread or any other primitives which are not able to be derived from information contained in the data packet itself.

### BRIEF SUMMARY OF THE INVENTION

According to the present invention, techniques for computer networking are provided. More particularly, the present invention provides a method and system for shaping packet switched data traffic between a terminal device of a type including an operating system adapted to execute a plurality of applications and a network resource. Merely by way of example, the present invention can be applied to network multitasking operations, but it would be recognized that it has a much broader range of applicability.

It is an object of the present invention to provide a traffic shaping system and method that overcomes or at least substantially ameliorates the problems associated with the prior art.

Other objects and advantages of the present invention will become apparent from the following description, taken in connection with the accompanying drawings, wherein, by way of illustration and example, an embodiment, of the present invention is disclosed.

It has been discovered that for a given user at a given computer device, in most cases only one application will be in active use. This means that although there may be multiple applications resident and running on a computer device such as spreadsheets and internet browsers, there is normally only one application, at a given point in time, that the user interacts with or from which the user expects a timely response.

Further, using a multitasked operating system such as Linux, Windows or Unix, several ‘windows’ may be open and running that correspond to distinct tasks performed within a given application. An example is having two internet browser windows open in order to download a large file and surf the internet at the same time.

In one form of this invention although this may not necessarily be the only or indeed the broadest form of this there is proposed a method for shaping packet switched data traffic between a terminal device of a type including an operating system adapted to execute a plurality of applications and a network resource, characterized by selection of a allocation policy to allocate access to the resource between one or more primary applications and any remaining applications; selection of characteristics which shall define a primary application; examining interactions between one or more applications and the operating system to identify which of a plurality of applications are primary applications; classifying data packets according to their association with a primary application; allocating access to the network resource in accordance with said policy.

In preference the network resource is bandwidth on a link between the terminal and a network access point.

In preference the characteristic defining the primary application is that it is the subject of an interactive user's focus. It is likely that the user is only going to interact, or expect interactive response, with one process, window or task at a given time.

In preference the operating system is a windowed operating system wherein the characteristic defining the primary application is that it is executing in the active window.

In preference the classification of data packets offered to the network resource is made according to operating system primitives. The method uses a combination of operating system and application specific information to make intelligent and automated decisions regarding access to network resources such as bandwidth or latency.

In preference some data within the data packet is changed to indicate its classification.

In preference information about the data in a data packet which has been given a particular classification is stored, such that the classification of the packet can be later determined from examination of the data packet alone.

In preference the allocation policy is to provide a fixed larger percentage of access to the network resource to a primary application and to share a fixed smaller percentage of access to the network resource among all other applications.

The advantage of this method is that it is able to overcome many of the deficiencies of present methods of allocating network resources to traffic flows or applications, particularly in creating relevant and workable policies for end device computers.

In a further form of the invention, it may be said to reside in an arrangement which is adapted to identify the status whether active or not, of an application with a displayed window on a video display unit of a computer, and effect an identification for data directly associated with the active application and effect a priority access to a packet switched data traffic output.

In a further form of the invention, it may be said to reside in a traffic shaping system for shaping switched data traffic between a terminal device of a type including a windowed operating system adapted to execute a plurality of applications and a network resource being bandwidth on a link between the terminal and a network access point including means to select and record an allocation policy to allocate access to the resource between one or more primary applications and any remaining applications; means adapted to examine interactions between one or more applications and the operating system further adapted to identify which of a plurality of applications are primary applications; means adapted to classify data packets as being associated with a primary application; means adapted to provide access to the network resource in accordance with said policy.

In preference the system includes an application window traffic classifier means, said classifier means being adapted to classify data packets offered to the network resource according to operating system primitives.

In preference the system includes a data packet manager means adapted to allocate access to the network resource in accordance with said policy, said data packet manager means being adapted receive information from an application window traffic classifier means and to use this information to identify the classification into which a data packet falls.

In preference the application window traffic classifier means further includes application window detector means adapted to examine operating system primitive events to detect the existence of an application window.

In preference the application window traffic classifier means further includes application traffic detector means adapted to detect the status and use of any connection to the network resource by an application being executed by the operating system.

In preference the application window traffic classifier means further includes means adapted to receive input from the application window detector means and the application traffic detector means, to process this information with stored information describing specific operating system behaviour and to provide an output to the data packet manager means containing information as to the identification and classification of data packets.

An example implementation is to use system calls within the operating systems on a computer device to determine which application or window has the active focus and then mapping this to the network packet level. Common operating systems of the day have a notion of multiple windows of which the window with the active focus is given priority to CPU resources. By prioritizing access to the network interface on the computer device for the application or window which the user is currently using, this will ensure that the user will always get the maximum perceived performance possible from their network connection without having to explicitly assign a policy governing all the different applications in use on the computer, and their respective requirements.

A typical use case would be setting a percentage e.g. 60% of total bandwidth to be made available to the active application. Assuming for example that the active application is an internet browser which the user is using to surf the web whilst performing a database replication over the network in the background, then the internet browser would get 60% of the total bandwidth available to the computer device's network interface whilst the database replication, and any other background application or task, would share the remaining 40%. Taking advantage of a concept known to those versed in the art as Bandwidth borrowing, that is letting one application or traffic flow use available bandwidth above their allocated guarantee when not in use by other traffic flows, the database replication is not likely to be significantly slowed down due to the fact that internet browser traffic is inherently bursty.

This process of intercepting operating system calls to make automated network resource allocation decisions allows a number of benefits not available to existing policy based QoS methods.

It does not require an explicit list of applications and their bandwidth allocations. This is extremely valuable for home users where applications may be added or removed on a regular basis or where the large number of applications makes a specification of a minimum guaranteed bandwidth for each application unworkable.

It is possible to optimise bandwidth for specific applications or tasks without the need for configuration or detailed knowledge of application and network operations by the user.

Since access to the data content of a packet is not necessary at the network layer it allows effective shaping in encrypted environments, such as when VPN software is used.

### BRIEF DESCRIPTION OF THE DRAWINGS

For a better understanding of this invention it will now be described with respect to the preferred embodiment which shall be described herein with the assistance of drawings wherein;

FIG. 1 is a block diagram representation of a preferred embodiment of the present invention; and

FIG. 2 is a block diagram of the Application Window Traffic Classifier of FIG. 1; and

FIG. 3 is a functional relationship diagram for the Application Window Detector of FIG. 2; and

FIG. 4 is a functional relationship diagram for the Application Traffic Detector of FIG. 2; and

FIG. 5 is a diagram illustrating some possible scenarios for relating traffic streams to applications windows; and

FIG. 6 is a block diagram representation of the Data packet manager of FIG. 1; and

FIGS. 7a-7f are process flow diagrams showing the process of classification for a variety of operating system primitives.

### DETAILED DESCRIPTION OF THE INVENTION

According to the present invention, techniques for computer networking are provided. More particularly, the present invention provides a method and system for shaping packet switched data traffic between a terminal device of a type including an operating system adapted to execute a plurality of applications and a network resource. Merely by way of example, the present invention can be applied to network multitasking operations, but it would be recognized that it has a much broader range of applicability.

A preferred embodiment of the invention will be referred to as an Application Windows Traffic Management (AWTM) consisting of two major functional components, the Application Window Traffic Classifier (AWTC) and the Data Packet Manager (DPM).

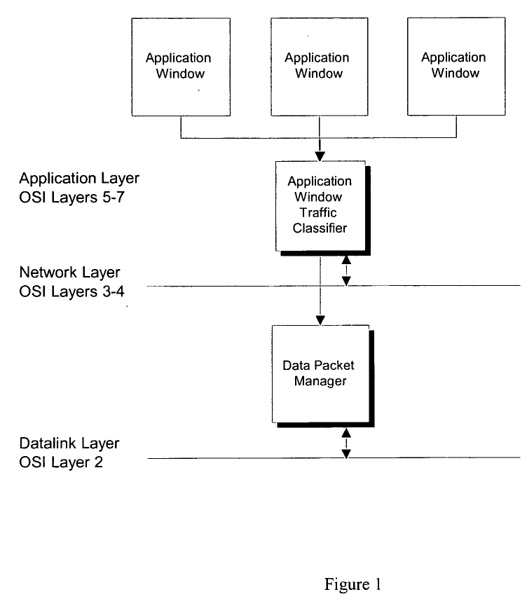

FIG. 1 shows that the inputs to AWTM consist of information from the Network Layer, corresponding to Layers 3 and 4 in the Open Systems Interconnect (OSI) model, the Datalink Layer, corresponding to Layer 2 in the OSI model, and the Application Layer, corresponding to Layers 5-7 in the OSI model. Based upon the user's interaction with a set of application windows and their associated traffic, the AWTM sends messages to the DPM in order for the DPM to classify and manage traffic entering to and from the Datalink Layer.

This network-centric architecture is independent of the Operating System, Application or hardware upon which the invention is implemented. The primary function of the AWTM is to create an association between an application window and its traffic based upon knowledge of the application and operating system, the users interaction with a set of application windows and a rule-set which determines the behavior of the AWTM based on a set of pre-defined conditions.

The DPM receives messages from the AWTM which enable it to classify packets entering and leaving the communications temminal according to these operating system primitives, and then applies a policy with respect to the allocation of network resources to these packets. An example of such a policy would be “Allocate 70% of available network resources to the Application Window the User is currently using, and 30% to any other Application Windows which may be generating traffic”.

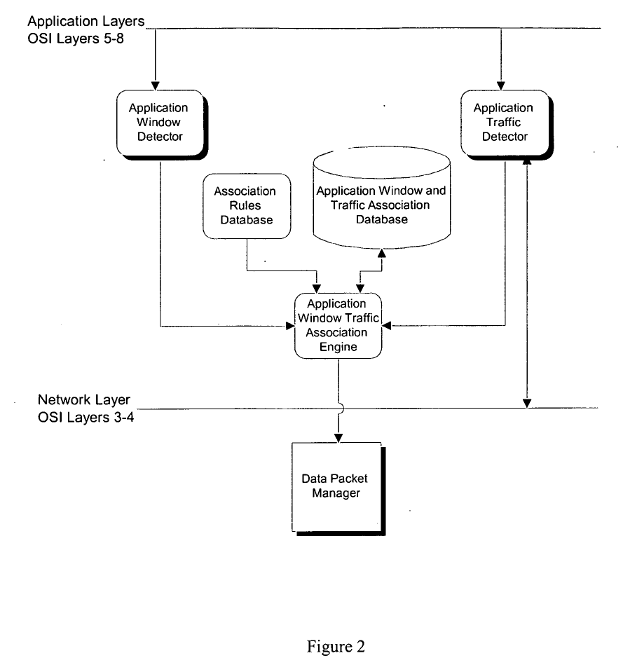

FIG. 2 illustrates the functional components of the AWTM in greater detail. The AWTM consists of the major subcomponents:
Application Window Detector
Application Traffic Detector
Association Rules Database
Application Window and Traffic Association Database
Application Window Traffic Association Engine

The Application Window Detector (AWD) tracks and communicates the identity of any live Application Windows to the Application Window Traffic Association Engine (AWTAE). An application Window can be uniquely identified according to its Process ID and Thread ID generated by the Operating System on creation. The AWD also communicates to the AWTAE any changes in states, such as if the Thread ID of the Active Window has changed, or if a Window has been closed (destroyed).

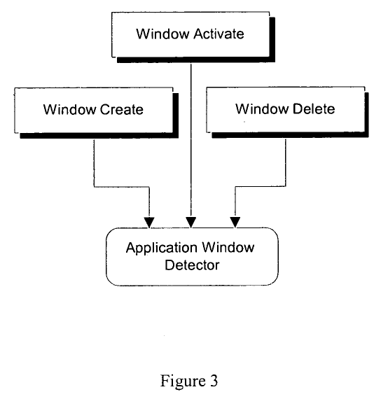

FIG. 3. shows the AWD intercepting Operating System messages corresponding to the creation, activation and deletion of a given window. Those versed in the art would understand that the AWD can potentially be implemented in both user space or in the kernel of an operating system. Equally, those versed in the art would understand that depending upon the operating system there are a number of Operating System events which may be used as a proxy for one of the Create, Activate and Close messages. For example, the Window Activate message may otherwise be interpreted from a Focus event in which a button, field or widget within a given window has the cursor focus which would imply that the Window containing the widget must be activated. In yet another embodiment of the invention, there may yet be another class of messages which allow for the management of Windows within Windows, which for the purposes of this invention could also be interpreted as a Windows event for interception.

The Application Traffic Detector (ATD) tracks and communicates the identity of any connections to and from the communications terminal. A connection can be uniquely identified according to its socket handle ID when it is created by a given Process Thread. A socket is a well known means for an application to interface with a network protocol stack on an operating system. The ATD also communicates to the AWTAE any changes in states, such as if the connection is closed, or if information is being read or written to the socket connection by a Process Thread.

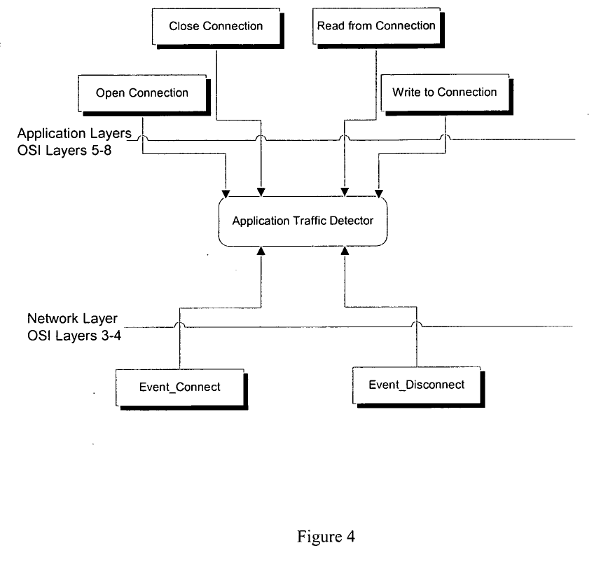

FIG. 4 illustrates the kinds of events that the ATD responds to. Events may be due to inbound or outbound oriented connections. A connection refers to any discrete communication channel established between two terminals, irrespective of the IP protocol e.g. could be UDP, TCP or other. An Open Connection event would occur when an application is either sending or receiving data packets. A Read from Connection Event would occur when a Process Thread attempts to receive information from an established connection. A Write to Connection Event would occur when a Process Thread attempts to send information to another application. A Close Connection event would occur when either the calling Process Thread has been signaled that there is no more information to be received from a sending application, or if a Process Thread has finished sending all information. The ATD sends the AWTAE the socket handle ID along with the calling Process ID and Thread ID for a given event. Those versed in the art would understand that along with or instead of the socket handle ID, other identifiers of the connection could also be used, such as Port Number, if they can uniquely identify a particular connection. Those versed in the art would also appreciate that depending upon the implementation of a protocol within an operating system stack, the name or description of an event may differ from those listed here, but would be functionally equivalent for the purposes of sending messages to establish and destroy a connection between two terminals.

The Association Rules Database (ARD) contains rules about how to associate a given Application Window with a connection for a given operating system, protocol and application. Because the Network Layer and the Application Layer are logically separated, there is not always a straight forward and consistent method in which an Application Window and Connection are related for a given operating system or application. New rules can be added for customized applications, or as complex application behaviors are discovered. Rules may be associated with one or more of the following: Operating System, Operating System Version, Operating System Patch Level, Application, and Application version. If no rule is found then a default association rule is returned.

A rule may be implemented either declaratively or in logic. The generalized structure of a rule is a logical IF-THEN structure, where the IF section is defined by a precondition and a rule, and the THEN is an action, instruction or code to be executed.

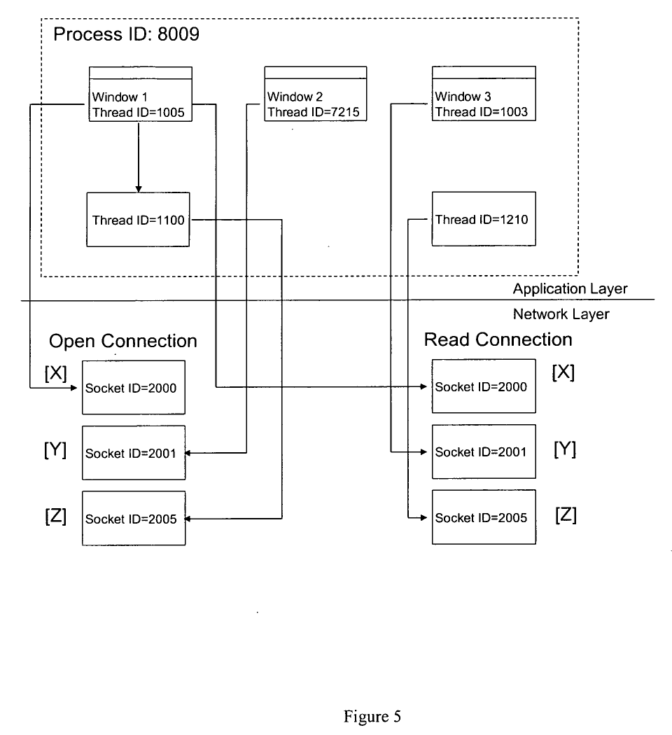

To understand how the ARD is used by the AWTEA, FIG. 5 illustrates some of the complexity of associating an Application Window and its corresponding data traffic for an Internet Browser process:

In one instance [X], the Process Thread ID associated with an Application Window is the same thread that both creates and reads from a connection.

In one instance [Y], the data traffic corresponding to a download window is first opened by a thread belonging to another application window before the download window resumes control of the connection by way of a Read Connection call.

In one instance [Z], a connection associated with a browser window thread is opened by a spawned thread ID and then read by yet another thread.

In each of these instances, the AWTAE may query the ARD in order to determine the behaviour of the system for a given operating system and application. For example, in instance [Y], the ARD may instruct the AWTAE to associate the connection with the Thread ID that performed the Read Connection call rather than the Open Connection call. By way of another example, in instance [Z] the ARD may instruct the AWTAE to associate the connection with the original browser window.

The Application Window and Traffic Association Database (AWTAD) stores for each process ID a list of alive thread IDs for that process ID, an indicator if the thread is a window thread, and a socket ID for that thread if one exists. Other information can also be stored, such as Layer 3 and 4 packet descriptors of traffic on a given connection depending upon the implementation.

The AWTAE creates an association, based upon the ARD, between an Application Window Thread ID and one or more Socket Handle IDs, and updates the AWTAD to keep track of all live threads and connections for a given process ID.

The AWTAE then communicates to the DPM the means of identifying which traffic belongs to the activated window, or window of interest, via an event message. The ARD contains rules under which circumstances and what type of event message is sent to the DPM, in a manner similar to the way that associations are dependant on the operating system and application. The events sent to the DPM are:
Add Classification event: This event corresponds to when a new window is activated. The AWTC supplies the DPM with the means of associating data packets with the active application window, or any other window of interest.
Update Classification event: This event corresponds to when a new connection is associated with an existing active window, or when a connection previously associated with an active window is no longer alive or no longer associated with the active window.
Delete Classification event: This event removes any existing classifications registered with the DPM.

One embodiment of the invention is for the event messages to contain traffic descriptors of data packets which are to be associated with the active window. These packet descriptors could be based upon fields in the packet header, or information contained within the data packet itself. Another embodiment is to mark data packets with a signature that the DPM is able to interpret as belonging to an active window such that the event message does not have to contain classification instructions itself In this instance, an activated window could be represented by any number of schemes with one example being a Diffserv code point (Differentiated Services RFC 2998) that a policy implemented in the DPM understands to be associated with traffic belonging to the active window. The advantage of marking the packet is that it could be used, via prior art methods such as Diffserv, to communicate a quality of service treatment to network nodes between two communication terminals.

Table A provides an example of the rules stored in the ARD and the corresponding association and message event. For a given operating system and application, the ARD is able to inform the system how to behave when a given connection is shared by different classes of threads such as the Active Window and a non-active window, or Anonymous Thread (an anonymous thread is one which is not directly associated with an application window). Using the first row as an example, it the ARD tells the AWTAE to update the AWTAD and send an Update Classification message to the DPM when it detects that a connection which was previously associated with the Active Window is now being controlled by a non-active window. In this case, the connection Socket ID in the AWTAD is updated with the new window's Thread ID and a message is sent to the DPM which informs it to no longer apply a policy based upon the data traffic associated with that connection.

TABLE A

| IF | | | | THEN | |
|---|---|---|---|---|---|
| | | Rule | | Action | |
| Pre-Condition | | Connection | Connection | Update | |
| OS | Application | From | To | Association? | Send Message? |
| Windows | Internet | Active | Non-Active | Yes | Send Update |
| XP | Explorer | Window | Window | | Classification |
| | | | | | (Remove) |
| Windows | Internet | Active | Anonymous | No | None |
| XP | Explorer | Window | Thread | | |
| Windows | Internet | Non-Active | Active | Yes | Update |
| XP | Explorer | Window | Window | | Classification |
| | | | | | (Add) |
| Windows | Internet | Non-Active | Anonymous | No | None |
| XP | Explorer | Window | Thread | | |
| Windows | Internet | Non-Active | Non-Active | Yes | None |
| XP | Explorer | Window | Window | | |
| Windows | Internet | Anonymous | Active | Yes | None |
| XP | Explorer | Thread | Window | | |
| Windows | Internet | Anonymous | Non-Active | Yes | Send Update |
| XP | Explorer | Thread | Window | | Classification |
| | | | | | (Remove) |
| Windows | Internet | Anonymous | Anonymous | No | None |
| XP | Explorer | Thread | Thread | | |

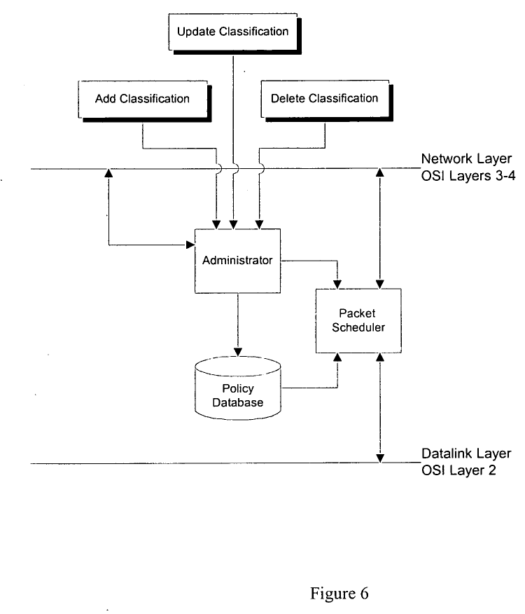

The Data Packet Manager controls the allocation of traffic based upon a set of network policies and classification and event information supplied by the AWTC. FIG. 6 shows that the DPM consists of the following functional modules:
Policy Database (PD)
Packet Scheduler (PS)
Administrator (ADM)

The policy database (PD) consists of one or more policies that can be applied to the Packet Scheduler (PS) based on a set of criteria. The set of criteria is a means by which a given policy may be enacted and does not necessarily relate to traffic parameters, for example time of day or day of the month. A policy consists of a filter and a service class. A filter can contain a list of arguments and values that correspond to attributes of data packets, either header or data, upon which a service class is to be applied. A service class contains information with respect to how network resources are to be allocated to that class. For example, a policy with respect to management of the traffic of the Active Window may have a filter which contains the argument “Diffserv” with value set to “1” with a service policy that guarantees 70% of all available bandwidth to traffic matching the filter. In this example, if the AWTC updates the diffserv field to “1” for all traffic corresponding to the Active Window, this will have the effect of ensuring that Active Window traffic will get 70% of all available bandwidth.

The PS interfaces with the Datalink Layer and is responsible for managing queues of data packets incoming and outgoing to the communication terminal. Queues are managed by prioritizing some packets by moving them ahead in a queue, or by delaying the transmission of other packets. The effect of managing these queues based upon policies supplied by the PD is to be able to control the percentage of bandwidth, or speed, given to a class of traffic. Another effect of managing the queue is to be able to also control the latency or jitter of a traffic flow.

Those versed in the art would also appreciate that this patent may also be extended to any data packet related action that may be undertaken based upon the method of associating a connection with an application window. Examples of other actions that may be taken, other than the allocation of network resource, are:
Mark the packet with a signature
Encrypt a data packet
Forward the data packet to a different address
Compress the data packet
Drop the data packet
Send a message to the sender or receiver of the data traffic
Perform a protocol translation.

The Administrator (ADM) receives event messages and classification information sent from the AWTC to the DPM and determines the action to be taken based upon the event. If packet descriptors have been supplied with the event message, the ADM updates a policy on the PD with the relevant packet descriptors, and then applies the updated policy to the PS. If packet descriptors have not been supplied, and instead the packet themselves have been updated with the classification information, the ADM may instead re-mark any packets that are queued. For example, if there are five packets waiting to be sent which are marked as belonging to the active window and the ADM receives a Delete Classification event the ADM may, depending on the implementation, reclassify those packets by updating their signature to correspond to a non-active window.

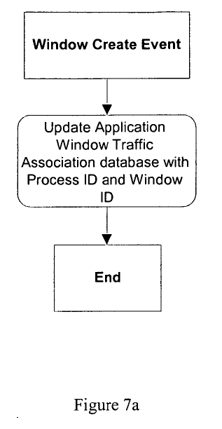

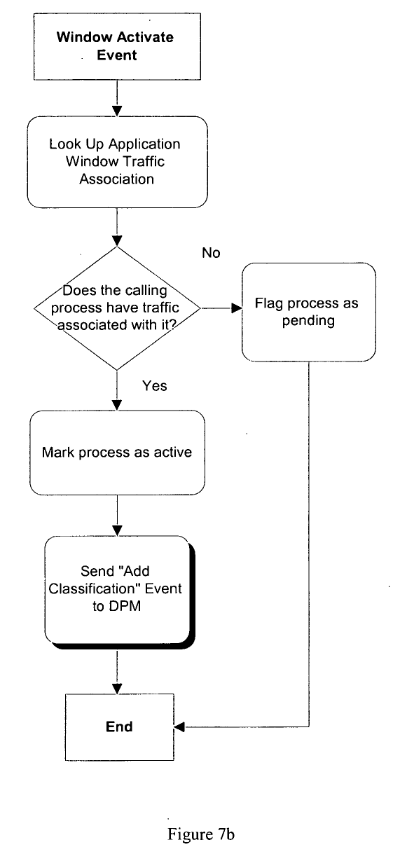

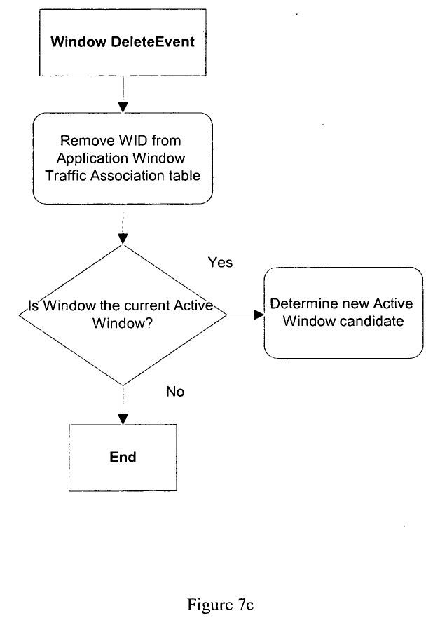

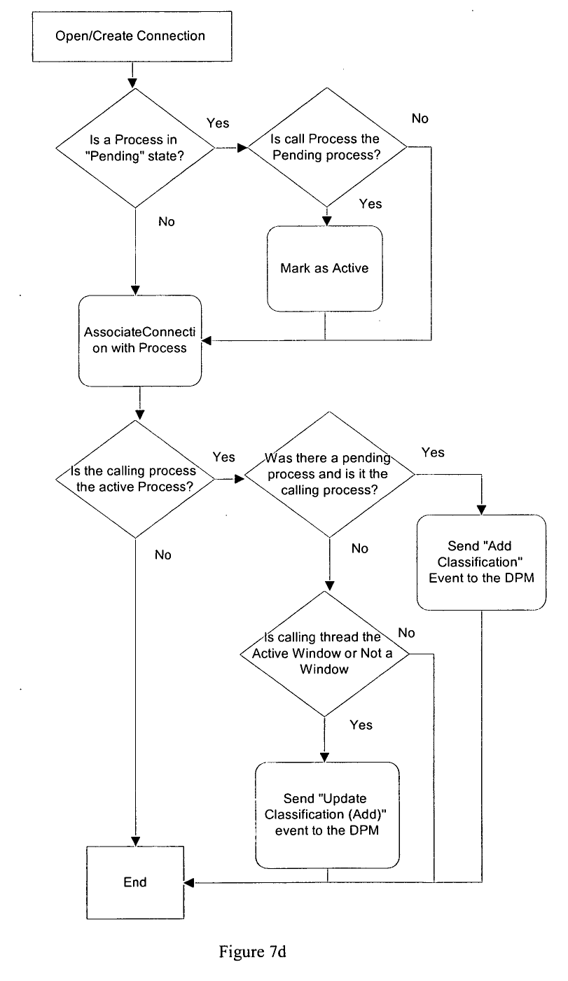

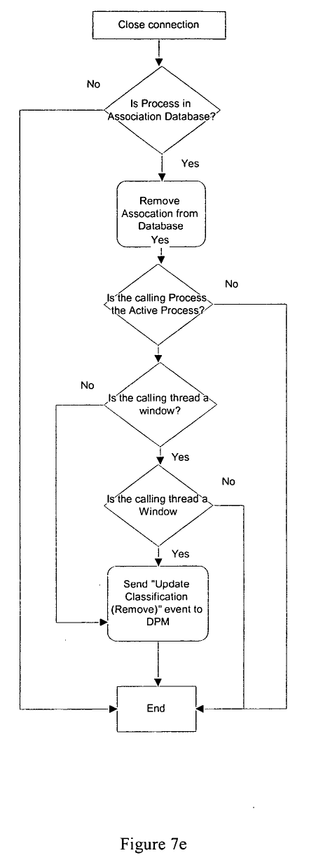

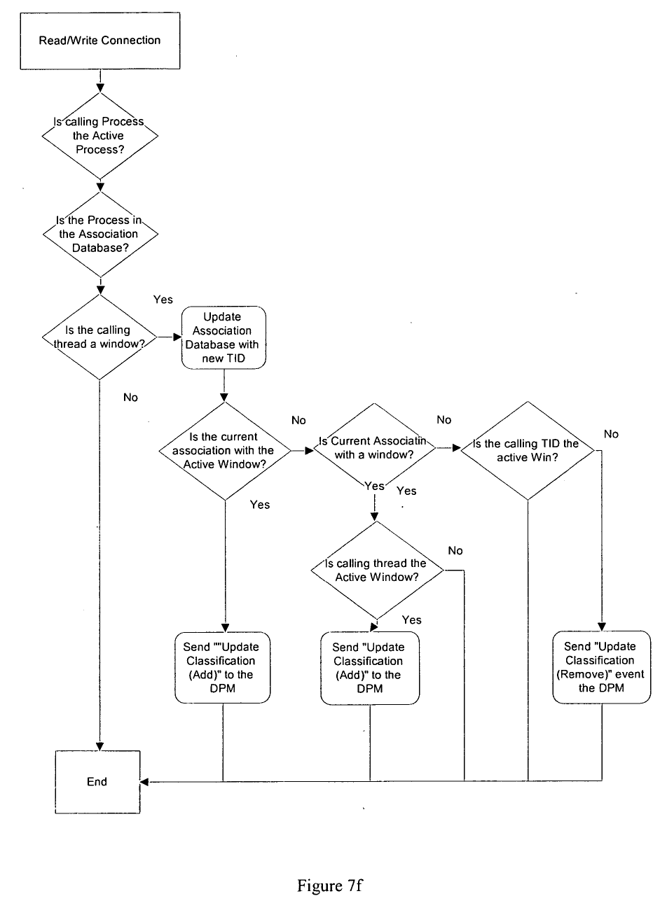

As described previously, the AWTC updates associations between a window and a connection, and classification information to the Data Packet Manager. FIGS. 7a-7f provide example process flows of the Application Window Traffic Classifier in response to events intercepted by the Application Window Detector, namely Window Create, Window Delete and Window Activate; and events intercepted by the Application Traffic Detector, namely Open Connection, Close Connection and Read/Write Connection.

Although the invention has been herein shown and described in what is conceived to be the most practical and preferred embodiment, it is recognised that departures can be made within the scope of the invention, which is not to be limited to the details described herein but is to be accorded the full scope of the appended claims so as to embrace any and all equivalent devices and apparatus.

1. A method for providing end point traffic management through computer networks, the method comprising:
operating a software based computer application at a client device, the application being one of a plurality of applications, the client device being coupled to a computer network;
automatically determining if the application is communicating through the network;
automatically selecting a policy for the application, the policy being one of a plurality of policies;
automatically allocating a selected level of bandwidth using the policy for the application; and
repeating the operating, determining, selecting, and allocating for another application from the plurality of applications.

2. The method of claim 1 wherein the method is provided on the client device.

3. The method of claim 1 wherein the application is selected from electronic mail, web browsing, instant messaging, voice, video, gaming, streaming, downloading, file transferring, and transaction processing.

4. The method of claim 1 wherein the application is coupled to an operating system.

5. The method of claim 4 wherein the operating system is Windows-based, Linux based, Unix based, and Java based.

6. A method for providing end point traffic management for delay sensitive traffic through computer networks, the method comprising:
operating a voice over IP application at a client device, the voice over IP application being one of a plurality of applications, the client device being coupled to a computer network;
determining if the voice over IP application is communicating through the network;
selecting a policy for the voice over IP application, the policy being one of a plurality of policies;
allocating a selected level of bandwidth using the policy for the application; and
maintaining the selected level of bandwidth while at least one other application is running on the client device.

7. The method of claim 6 wherein the method is provided automatically on the client device.

8. The method of claim 6 wherein the other application is a download of a file from the network.

9. A method for shaping packet switched data traffic between a terminal device of a type including an operating system adapted to execute a plurality of applications and a network resource, the method comprising:
selecting of an allocation policy to allocate access to the network resource between one or more primary applications and other applications;
selecting characteristics associated with a primary application;
examining interactions between one or more applications and the operating system to identify which of a plurality of applications is the primary application;
classifying data packets according to their association with the primary application;
allocating access to the network resource in accordance with the policy.

10. The method of claim 9 wherein the primary application comprising an interactive characteristic.

11. The method of claim 10 wherein the interactive characteristic is derived from a real time delay sensitive application consisting of voice over IP, an interactive game, H.323 video conferencing, and video conferencing.

12. The method of claim 9 wherein the primary application comprising a streaming characteristic.

13. The method of claim 12 wherein the streaming characteristic is selected from video streaming, audio streaming, and data streaming.

14. The method of claim 9 wherein the application is selected by a user to be the primary application.

15. The method of claim 9 wherein the primary application is selected by a user using a pointing device.

16. A traffic shaping system for shaping switched data traffic between a terminal device of a type including a windowed operating system adapted to execute a plurality of applications and a network resource being bandwidth on a link between the terminal and a network access point, the system comprising:
means to select and record an allocation policy to allocate access to the resource between one or more primary applications and any remaining applications;
means adapted to examine interactions between one or more applications and the operating system further adapted to identify which of a plurality of applications are primary applications;
means adapted to classify data packets as being associated with a primary application;
means adapted to provide access to the network resource in accordance with said policy.

17. A method for providing end point traffic management for delay sensitive traffic through computer networks, the method comprising:
selecting an application at a client device associated with traffic through the computer network, the application being operable with the traffic that is characterized as delay sensitive;
operating the application at the client device, the application being one of a plurality of applications, the client device being coupled to a computer network;
determining if the application is communicating through the network;
selecting a policy for the application, the policy being one of a plurality of policies;
allocating a selected level of bandwidth using the policy for the application; and
maintaining the selected level of bandwidth while at least one other application is running on the client device.
